(19) United States
(12) Patent Application Publication
(10) Pub. No.: US 2019/0340601 A1
(43) Pub. Date: Nov. 7, 2019

(54) Method And Mobile Device For Transmitting Data By Using Barcode

(71) Applicant: HUAWEI TECHNOLOGIES CO., LTD., Shenzhen, Guangdong (CN)

(72) Inventor: Weihong WANG, Shenzhen (CN)

(21) Appl. No.: 16/474,624

(22) PCT Filed: Dec. 30, 2016
(86) PCT No.: PCT/CN2016/113953

§ 371 Date: Jun. 28, 2019

(51) Int. Cl. G06Q 20/32; G06K 7/14; G06K 7/10

(52) U.S. Cl. CPC G06Q 20/3274; G06K 7/10722; G06K 7/1413

(57) ABSTRACT

The present disclosure relates to methods for transmitting data by using a barcode. One example method includes receiving a mobile payment instruction, determining, by a mobile device, whether mobile payment information exists, where the mobile payment information is discount information of a mobile payment application, determining, based on the discount information, an application for performing mobile payment, determining, whether a particular light ray emitted by a scanner of a payment terminal is shining on the mobile device, in response to determining that the particular light ray is shining on the mobile device, invoking, a barcode that is used by the application program for mobile payment, displaying the barcode on a display of the mobile device, receiving a payment success message, and displaying a payment success user interface on the display.

### TECHNICAL FIELD

The present invention relates to the field of data processing, and in particular, to a method and a mobile device for transmitting data by using a barcode.

### BACKGROUND

With rapid development of mobile payment, especially, with high-speed expansion of a third-party mobile payment application (such as Alipay or WeChat) installed on a mobile device, a payment terminal supporting the third-party mobile payment application is laid in physical stores such as a restaurant, a supermarket, and a cinema in a city. The payment terminal can perform a financial transaction by scanning a barcode displayed on a mobile device, so as to implement offline cashless payment, avoiding inconvenience of carrying a wallet and a bank card.

However, the current mobile payment requires many operation steps, and is extremely cumbersome for use. For example, when a user performs barcode-scanning payment by using Alipay, for each transaction, the user needs to first unlock a mobile phone screen, find an Alipay application, open an Alipay application interface, enter a multi-level menu to open and display a barcode payment page, and then present the barcode payment page to a payment terminal for scanning, to finally complete mobile payment. Apparently, operations of the foregoing mobile payment manner are extremely cumbersome, and consequently, efficiency of performing mobile payment by a mobile device is greatly reduced.

### SUMMARY

To resolve the foregoing technical problem, embodiments of this application provide a method and a mobile device for transmitting data by using a barcode. A sensor (such as a light/distance sensor) detects an operation of a scanner of a payment terminal, so that a barcode payment interface is automatically invoked to complete quick barcode-scanning payment. This reduces a user operation step, and improves mobile payment efficiency, thereby enhancing user experience.

According to a first aspect, an embodiment of this application provides a method for transmitting data by using a barcode. The method includes: receiving, by a mobile device, a mobile payment instruction; determining, by the mobile device, whether there is mobile payment information, where the mobile payment information is discount information of a mobile payment application program; determining, by the mobile device based on the discount information, an application program for performing mobile payment; determining, by the mobile device through detection by using a light sensor, whether there is a particular light ray emitted by a scanner of a payment terminal shining on the mobile device; when the light sensor detects that there is a particular light ray shining on the mobile device, invoking, by the mobile device, a barcode that is used by the application program for mobile payment, and displaying the barcode on a display of the mobile device; and receiving, by the mobile device, a payment success message sent by a network side, and displaying a payment success user interface on the display. In the technical solution, the mobile device can quickly and efficiently perform mobile payment, and user experience can be improved.

In some embodiments, the barcode may be a one-dimensional barcode or a QR code in a two-dimensional barcode.

According to a second aspect, an embodiment of this application provides a method for transmitting data by using a barcode. The method includes: presetting, on a mobile device, a mobile payment application program used for quick payment; determining, by the mobile device, whether a quick payment condition is met; and when the quick payment condition is met, displaying a barcode on a display of the mobile device, where the barcode is a barcode that is used by the application program for mobile payment.

In some embodiments, the method may further include: receiving, by the mobile device, a payment message sent by a network side, and prompting a user on the mobile device based on the payment message.

In some embodiments, the determining, by the mobile device, whether a quick payment condition is met specifically includes: detecting, by a sensor in the mobile device, whether there is a particular light ray shining on the mobile device.

In some embodiments, the determining, by the mobile device, whether a quick payment condition is met specifically includes: detecting, by an acceleration sensor in the mobile device, whether an acceleration exceeds a predetermined threshold, and detecting, by an ambient light sensor, whether there is a particular light ray shining on the mobile device.

In some embodiments, the displaying a barcode on a display of the mobile device specifically includes: displaying at least two different types of barcodes on the display.

In some embodiments, the presetting, on the mobile device, a mobile payment application program used for quick payment specifically includes:

automatically setting, by the mobile device based on a date or a geographic location, the mobile payment application program used for quick payment.

According to a third aspect, an embodiment provides a mobile device for transmitting data by using a barcode. The mobile device includes one or more processors, a display, a memory, and one or more programs, the one or more programs are stored in the memory and are configured to be executed by the one or more processors, and the one or more programs include: receiving, by the mobile device, a mobile payment instruction; determining, by the mobile device, whether there is mobile payment information, where the mobile payment information is discount information of a mobile payment application program; determining, by the mobile device based on the discount information, an application program for performing mobile payment; determining, by the mobile device through detection by using a light sensor, whether there is a particular light ray emitted by a scanner of a payment terminal shining on the mobile device; when the light sensor detects that there is a particular light ray shining on the mobile device, invoking, by the mobile device, a barcode that is used by the application program for mobile payment, and displaying the barcode on the display of the mobile device; and receiving, by the mobile device, a payment success message sent by a network side, and displaying a payment success user interface on the display.

According to a fourth aspect, an embodiment provides a mobile device for transmitting data by using a barcode. The mobile device includes a processor, a display, a memory, and one or more sensors, where the processor sets a mobile payment application program used for quick payment, and stores the mobile payment application program in the memory; the processor determines whether a quick payment condition is met; and when determining that the quick payment condition is met, the processor displays a barcode on the display, where the barcode is a barcode that is used by the application program for mobile payment.

In some embodiments, after receiving a payment message sent by a network side, the processor prompts a user on the display based on the payment message.

In some embodiments, that the processor determines whether a quick payment condition is met specifically includes: detecting, by the one or more sensors, whether there is a particular light ray shining on the display.

In some embodiments, that the processor determines whether a quick payment condition is met specifically includes: detecting, by the one or more sensors, whether an acceleration exceeds a predetermined threshold, and detecting whether there is a particular light ray shining on the display.

In some embodiments, that the processor sets a mobile payment application program used for quick payment specifically includes: automatically setting, by the processor based on a date or a geographic location, the mobile payment application program used for quick payment.

In the foregoing embodiments, the mobile payment application program used for quick payment is preset on the mobile device. When the mobile device performs mobile payment, the user does not need to perform some complex operations to select a specific mobile payment manner to complete payment, but the mobile device automatically determines the application program used for quick payment to perform mobile payment. In this way, time is saved, processing efficiency of the mobile device is improved, and user experience is improved.

It should be understood that descriptions of technical features, technical solutions, beneficial effects, or similar statements in the specification do not imply that all features and advantages can be implemented in any single embodiment. However, it may be understood that the descriptions of the features or beneficial effects mean that at least one embodiment includes a particular technical feature, technical solution, or beneficial effect. Therefore, in this specification, the descriptions of the technical features, technical solutions, or beneficial effects may not refer to a same embodiment. In addition, the technical features, technical solutions, and beneficial effects described in the embodiments may be further combined in any proper manner. Persons skilled in the art may understand that a particular embodiment may be implemented without using one or more particular technical features, technical solutions, or beneficial effects. In other embodiments, additional technical features and beneficial effects may be further identified in particular embodiments that may not be present in all embodiments.

### BRIEF DESCRIPTION OF DRAWINGS

FIG. 1 is a schematic diagram of a communication environment in which a smartwatch is located according to some embodiments;

FIG. 2 is a schematic diagram of a hardware structure of a smartwatch according to some embodiments;

FIG. 3 is a schematic diagram of a hardware structure of a mobile phone according to some embodiments;

FIG. 4 is a flowchart of a mobile payment method according to some embodiments;

FIG. 5 is an example user interface displayed on a smartwatch according to some embodiments;

FIG. 6A to FIG. 6C are other example user interfaces displayed on a smartwatch according to some embodiments;

FIG. 7A to FIG. 7D are different types of barcodes displayed on a mobile device according to some embodiments;

FIG. 8 is a schematic diagram of a network architecture of mobile payment according to some embodiments;

FIG. 8 is a flowchart of a quick payment method according to some embodiments;

FIG. 9 is a schematic diagram of hardware of a mobile device according to some embodiments; and

FIG. 10 is a schematic diagram of a quick payment method according to some embodiments.

### DESCRIPTION OF EMBODIMENTS

The terms used in the descriptions of the present invention in this specification are merely for the purpose of describing specific embodiments, and are not intended to limit the present invention. The terms “one”, “a” and “this” of singular forms used in this specification and the appended claims of the present invention are also intended to include plural forms, unless otherwise specified in the context clearly.

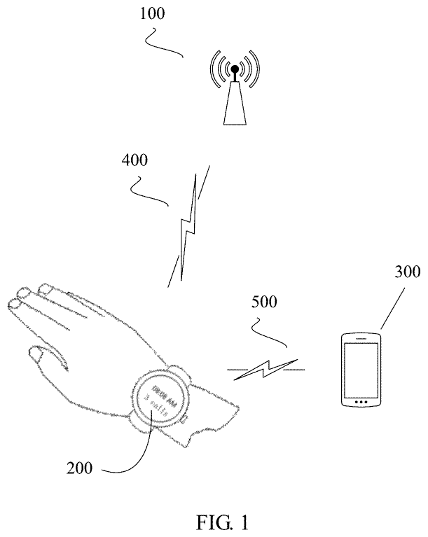

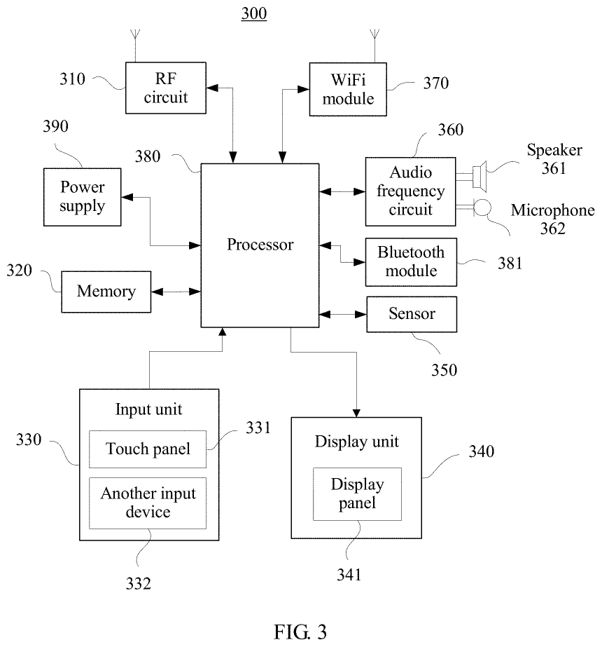

A mobile device in the following embodiments may be various devices having a wireless communication function. For example, the mobile device may be a wearable device (such as a smartwatch 200 shown in FIG. 1) having a wireless communication function, may be a mobile phone 300 shown in FIG. 3, or may be a tablet computer. The mobile device is not specifically limited in the following embodiments.

As shown in FIG. 1, an embodiment provides a smartwatch 200. The smartwatch 200 may perform wireless network communication with a network-side base station 100 or a mobile phone 300 in a wireless manner. For example, the smartwatch 200 may send a wireless signal to the base station 100 by using a wireless communication link 400, and a radio frequency circuit and an antenna of the smartwatch 200, to request the base station 100 to perform a wireless network service to process a specific service requirement of the smartwatch 200. For another example, the smartwatch 200 may perform matching with the mobile phone 30 by using Bluetooth of the smartwatch 200, and perform data communication with the mobile phone by using a Bluetooth communication link 50 after the matching succeeds. Certainly, the smartwatch may alternatively perform data communication with the mobile phone in another wireless communication manner, such as a radio frequency identification technology or a Near Field Communication technology. In addition, the smartwatch 200 may also detect a change of an external environment by using various sensors of the smartwatch 200.

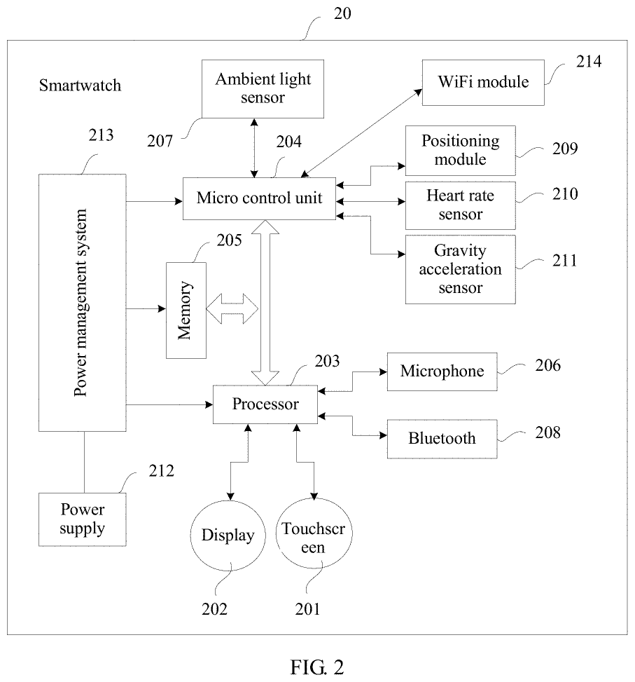

As shown in FIG. 2, the smartwatch 200 may specifically include a watch body and a wrist strap (not shown in FIG. 2) that are connected to each other. The watch body may include a touch panel 201 (also referred to as a touchscreen), a display 202, a processor 203, a micro control unit (MCU for short) 204, a memory 205, a microphone 206, an ambient light sensor 207, a Bluetooth module 208, a positioning module 209, a heart rate sensor 210, a gravity acceleration sensor 211, a power supply 212, a power management system 213, a WiFi module 214, and the like. Although not shown, the smartwatch may further include an antenna, a Near Field Communication (NFC for short) module, a speaker, an accelerometer, a gyroscope, and the like.

Each function component of the smartwatch 200 is described below.

The touchscreen 201, also referred to as the touch panel, may collect a touch operation performed by a user of the smartwatch 200 on the touchscreen (for example, an operation performed by the user on or near the touch panel by using any proper object or accessory such as a finger or a stylus), and drive a corresponding connection apparatus based on a preset program. Optionally, the touch panel 201 may include two parts: a touch detection apparatus and a touch controller. The touch detection apparatus detects a touch position of the user, detects a signal brought by the touch operation, and transfers the signal to the touch controller. The touch controller receives touch information from the touch detection apparatus, converts the touch information into coordinates of a touch point, and then sends the coordinates to the processor 203. In addition, the touch controller can receive and execute a command sent by the processor 203. In addition, the touch panel may be implemented in a plurality of types, for example, a resistive type, a capacitive type, an infrared ray, and a surface acoustic wave. In addition to the touchscreen 201, the smartwatch may further include another input device, and the another input device may include but is not limited to a function key (such as a volume control key or an on/off key).

The display 202 may be configured to display information entered by the user or information provided for the user and various menus of the watch. Optionally, the display 202 may be configured in a form such as a liquid crystal display (LCD for short) or an organic light-emitting diode (OLED for short). Further, the touch panel 201 may cover the display 202. After detecting the touch operation on or near the touch panel 201, the touch panel 201 transfers the touch operation to the processor 203 to determine a type of a touch event. Then, the processor 203 provides corresponding visual output on the display 202 based on the type of the touch event. Although the touch panel 201 and the display 202 in FIG. 2 are used as two independent components to implement input and output functions of the watch, in some embodiments, the touch panel 201 and the display 202 may be integrated to implement the input and output functions of the watch.

The processor 203 is configured to: perform system scheduling, control the display 202 and the touchscreen 201, and support processing of the microphone 206, the Bluetooth 208, and the like. For example, the processor 203 may be a Kirin 960 chip of Huawei Technologies Co., Ltd.

The microphone 206 may convert a collected sound signal into an electrical signal. After receiving the electrical signal, an audio frequency circuit converts the electrical signal into audio data. The audio frequency circuit may also convert audio data into an electrical signal, and transmit the electrical signal to the speaker, and the speaker converts the electrical signal into a sound signal for output.

Bluetooth 208: The smartwatch may exchange information with another electronic device (such as the mobile phone 300) through Bluetooth, and is connected to a network by using the electronic device, so as to be connected to a server, and process a function such as speech recognition.

The micro control unit 204 is configured to: control the various sensors, collect data from the various sensors, perform a preliminary operation on the data from the sensors, and communicate with the processor 203. The sensor may be a barometric pressure sensor, the heart rate sensor 210, the gravity acceleration sensor 211, a light sensor, a motion sensor, or another sensor. Specifically, the light sensor may include an ambient light sensor and a proximity sensor. For other sensors such as the gyroscope, a barometer, a hygrometer, a thermometer, and an infrared sensor that may be further configured in the watch, details are not described herein.

The memory 205 is configured to store a software program and data. The processor 203 executes various functional applications of the watch 200 and data processing by running the software program and the data that are stored in the memory. The memory 205 mainly includes a program storage area and a data storage area. The program storage area may store an operating system, and an application program required by at least one function (such as a sound playing function or an image displaying function). The data storage area may store data (such as audio data or a phone book) created based on use of the watch. In addition, the memory may include a high-speed random access memory, or may include a non-volatile memory, for example, a magnetic disk storage device, a flash memory device, or another volatile solid-state storage device. In this embodiment, the memory 205 stores an operating system that enables the smartwatch to run, for example, a Watch operating system developed by Apple or an Android Wear® operating system developed by Google.

The watch further includes the power supply 212 (such as a battery) that supplies power to each component. The power supply 212 may be logically connected to the processor 203 by using the power management system 213, to implement functions such as charging management, discharging management, and power consumption management by using the power management system 213.

Each method in the following embodiment may be implemented in the smartwatch 200 having the foregoing hardware structure.

As shown in FIG. 3, a mobile device in an embodiment may be a mobile phone 300. The following describes the embodiment in detail by using the mobile phone 300 as an example.

It should be understood that the mobile phone 300 shown in the figure is merely an example of the mobile device, and the mobile phone 300 may have more or fewer components than those shown in the figure, or may combine two or more components, or may have different component configurations. Various components shown in the figure may be implemented in hardware that includes one or more signal processors and/or application-specific integrated circuits, or in software, or in a combination of hardware and software.

As shown in FIG. 3, the mobile phone 300 includes components such as an RF (Radio Frequency, radio frequency) circuit 310, a memory 320, an input unit 330, a display unit 340, a sensor 350, an audio frequency circuit 360, a WiFi module 370, a processor 380, and a power supply 390. Persons skilled in the art may understand that a structure of the mobile phone shown in FIG. 3 does not constitute a limitation on the mobile phone, and the mobile phone may include more or fewer components than those shown in the figure, or combine some components, or have different component arrangements.

Each constituent component of the mobile phone 300 is specifically described below with reference to FIG. 3.

The RF circuit 310 may be configured to: receive and send a signal in an information receiving or sending process or in a call process; particularly, after receiving downlink information of a base station, send the downlink information to the processor 380 for processing; and in addition, send related uplink data to the base station. Generally, the RF circuit includes but is not limited to an antenna, at least one amplifier, a transceiver, a coupler, a low noise amplifier, and a duplexer. In addition, the RF circuit 310 may further communicate with a network and another device through wireless communication. Any communications standard or protocol may be used for the wireless communication, including but not limited to a Global System for Mobile Communications, a general packet radio service, Code Division Multiple Access, Wideband Code Division Multiple Access, Long Term Evolution, an email, a short message service, and the like.

The memory 320 may be configured to store a software program and data. The processor 380 executes various functional applications of the mobile phone 300 and data processing by running the software program and the data that are stored in the memory 320. The memory 320 may mainly include a program storage area and a data storage area. The program storage area may store an operating system, an application program required by at least one function (such as a sound playing function or an image playing function), and the like. The data storage area may store data (such as audio data or a phone book) created based on use of the mobile phone 300, and the like. In addition, the memory 320 may include a high-speed random access memory, or may include a non-volatile memory, for example, at least one magnetic disk storage device, a flash memory device, or another volatile solid-state storage device. In this embodiment, the memory 320 stores an operating system that enables the mobile phone 300 to run, for example, an iOS® operating system developed by Apple, an Android® open-source operating system developed by Google, or a Windows® operating system developed by Microsoft.

The input unit 330 may be configured to: receive entered digit or character information, and generate key signal input related to user settings and function control of the mobile phone 300. Specifically, the input unit 330 may include a touch panel 331 and another input device 332. The touch panel 331, also referred to as a touchscreen, may collect a touch operation performed by a user on or near the touch panel (for example, an operation performed by the user on or near the touch panel 331 by using any proper object or accessory such as a finger or a stylus), and drive a corresponding connection apparatus based on a preset program. Optionally, the touch panel 331 may include two parts: a touch detection apparatus and a touch controller. The touch detection apparatus detects a touch position of the user, detects a signal brought by the touch operation, and transfers the signal to the touch controller. The touch controller receives touch information from the touch detection apparatus, converts the touch information into coordinates of a touch point, and then sends the coordinates to the processor 380. In addition, the touch controller can receive and execute a command sent by the processor 380. In addition, the touch panel 331 may be implemented in a plurality of types, for example, a resistive type, a capacitive type, an infrared ray, and a surface acoustic wave. In addition to the touch panel 331, the input unit 330 may further include other input devices 332. Specifically, the other input devices 332 may include but are not limited to one or more of a physical keyboard, a function key (such as a volume control key or an on/off key), a trackball, a mouse, and a joystick.

The display unit 340 may be configured to display information entered by the user or information provided for the user and various menus of the mobile phone 300. The display unit 340 may include a display panel 341 (namely, a display). Optionally, the display panel 341 may be configured in a form such as a liquid crystal display or an organic light-emitting diode. Further, the touch panel 331 may cover the display panel 341. After detecting the touch operation on or near the touch panel 331, the touch panel 331 transfers the touch operation to the processor 180 to determine a type of a touch event. Then, the processor 380 provides corresponding visual output on the display panel 341 based on the type of the touch event. Although the touch panel 331 and the display panel 341 in FIG. 3 are used as two independent components to implement input and output functions of the mobile phone 300, in some embodiments, the touch panel 331 and the display panel 341 may be integrated to implement the input and output functions of the mobile phone 300.

The mobile phone 300 may further include at least one sensor 350, such as a light sensor, a motion sensor, and another sensor. Specifically, the light sensor may include an ambient light sensor and a proximity sensor. The ambient light sensor may adjust luminance of the display panel 341 based on brightness of ambient light. The proximity sensor may turn off the display panel 341 and/or backlight when the mobile phone 300 approaches an ear. As a type of motion sensor, an accelerometer sensor may detect a value of an acceleration in each direction (usually, three axes), may detect a value and a direction of gravity when the mobile phone is still, and may be applied to an application for identifying a mobile phone posture (such as landscape-to-portrait switch, a related game, and magnetometer posture calibration), a function related to vibration identification (such as a pedometer or a stroke), and the like. For other sensors such as a gyroscope, a barometer, a hygrometer, a thermometer, and an infrared sensor that may be further configured in the mobile phone 300, details are not described herein.

The audio frequency circuit 360, a speaker 361, and a microphone 362 may provide an audio interface between the user and the mobile phone 300. The audio frequency circuit 360 may transmit, to the speaker 361, an electrical signal converted from received audio data, and the speaker 361 converts the electrical signal into a sound signal for output. In addition, the microphone 362 converts a collected sound signal into an electrical signal. After receiving the electrical signal, the audio frequency circuit 360 converts the electrical signal into audio data, and then outputs the audio data to the RF circuit 310 to send the audio data to, for example, another mobile phone, or outputs the audio data to the memory 320 for further processing.

WiFi is a short-distance wireless transmission technology. The mobile phone 300 may help, by using the WiFi module 370, the user receive and send an email, browse a web page, access streaming media, and the like. The WiFi module 370 provides wireless broadband Internet access for the user.

The processor 380 is a control center of the mobile phone 300, is connected to each part of the entire mobile phone by using various interfaces and lines, and executes various functions of the mobile phone 300 and data processing by running or executing the software program stored in the memory 320 and invoking the data stored in the memory 320, so as to perform overall monitoring on the mobile phone. In some embodiments, the processor 380 may include one or more processing units. An application processor and a modem processor may be further integrated into the processor 380. The application processor mainly processes an operating system, a user interface, an application program, and the like. The modem processor mainly processes wireless communication. It may be understood that the modem processor may alternatively be not integrated into the processor 180.

A Bluetooth module 381 exchanges information with another device by using a short-distance communications protocol such as Bluetooth. For example, the mobile phone 300 may establish, by using the Bluetooth module 381, a Bluetooth connection to the smartwatch 200 that also has a Bluetooth module.

The mobile phone 300 further includes the power supply 390 (such as a battery) that supplies power to each component. The power supply may be logically connected to the processor 380 by using a power management system, to implement functions such as charging management, discharging management, and power consumption management by using the power management system.

Although not shown, the mobile phone 300 may further include a camera and the like. Details are not described herein.

Each method in the following embodiment may be implemented in the mobile phone 300 having the foregoing hardware structure.

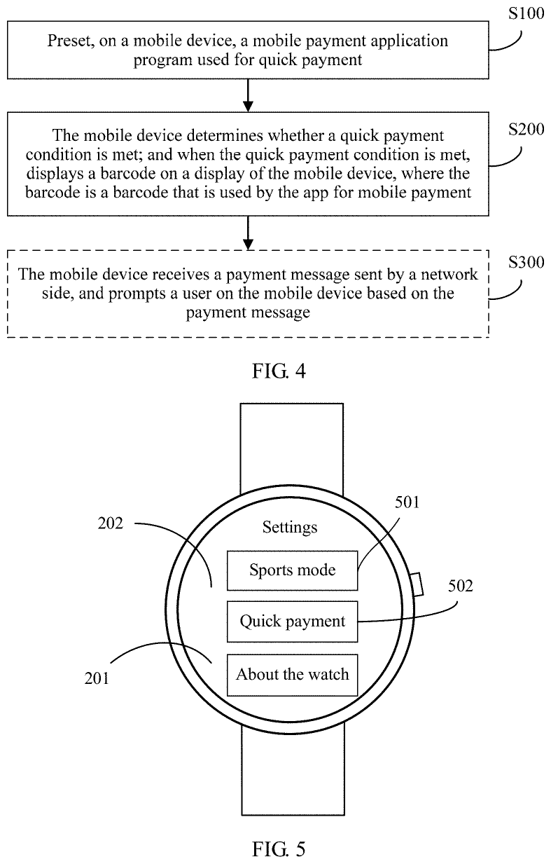

As shown in FIG. 4, an embodiment of the present invention provides a method for transmitting data by using a barcode. The method may be implemented in the smartwatch 200 or the mobile phone 300, or may be jointly completed through communication between the smartwatch 200 and the mobile phone 300. The method specifically includes the following steps.

S100. Preset, on a mobile device, a mobile payment application program used for quick payment.

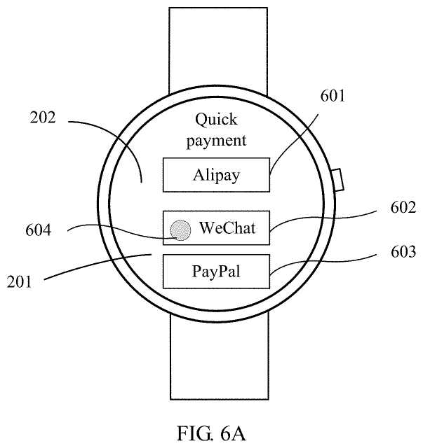

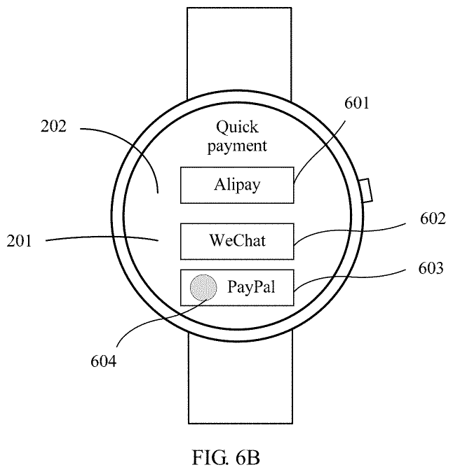

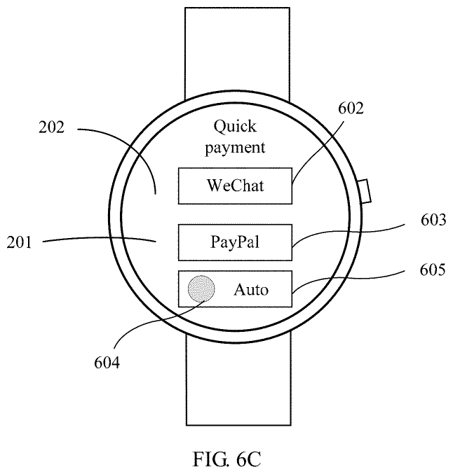

In the following embodiments, mobile payment may be specifically a payment manner in which a user uses the mobile device (usually a mobile phone or a wearable device) to pay for purchased commodities or services. For example, the mobile payment is payment performed by a mobile phone by using a barcode, or payment performed by a mobile phone having an NFC function. Quick payment is specifically a payment manner in which when the mobile device performs mobile payment, the mobile payment can be quickly completed without a need of performing complex operations by the user on the mobile device. Setting of the mobile payment application program used for quick payment may be completed by the user in the watch 200. As shown in FIG. 5, the display 202 of the watch 200 displays a settings menu. A sports mode 501 may include various sports such as walking, running, and swimming. Quick payment 502 may be used to set the mobile payment application program used for quick payment. When the user taps the displayed control 502, the touchscreen 201 receives touch information of the user, performs preliminary processing on the touch information, and sends the processed touch information to the processor 203. The processor 203 invokes, based on the received touch information, an instruction corresponding to the touch information, and the instruction may be: further opening a user interface of a payment manner. As shown in FIG. 6A, after the user taps the control 502 in FIG. 5, the display of the smartwatch 200 displays controls 601, 602, and 603, which represent application programs on which quick payment can be set. All these application programs may be used to perform mobile payment on the mobile device. Therefore, the application programs may also be referred to as mobile payment application programs. The control 601 indicates that Alipay may be set as the application program used for quick payment, the control 602 indicates that WeChat may be set as the application program used for quick payment, and the control 603 indicates that PayPal (PayPal) may be set as the application program used for quick payment. An icon 604 indicates that a current application program used for quick payment in the smartwatch 200 is WeChat. It may be understood that the user may change, by tapping another icon in a “quick payment” menu, the application program used for quick payment. As shown in FIG. 6B, when the user taps the control 603, it indicates that the current application program used for quick payment already changes from WeChat into PayPal. It may be understood that before determining to change the application program used for quick payment, the mobile device (for example, the watch or the mobile phone) may first pop up a prompt box on the display 202 to prompt the user whether to change WeChat used for quick payment into PayPal. The mobile device changes the application program used for quick payment only when receiving a response that the user determines to change the application program used for quick payment. In this way, a payment failure in a subsequent mobile payment process that is caused because a quick payment manner changes when the user unconsciously taps a control is avoided.

In the foregoing embodiment, the user manually sets the application program used for quick payment, so that mobile payment can be more quickly implemented, and time is also saved for subsequent mobile payment.

As shown in FIG. 6C, after the user performs a touch gesture of flicking upwards on the touchscreen 201, a user interface displayed on the display 202 may present more controls downwards in an animation form, for example, a control 605. When the user selects the control 605 (“Auto”), it indicates that the mobile device does not need a user operation, and may automatically set, based on various types of information currently received by the mobile device, the application program used for quick payment. Mobile payment efficiency is further improved in such an automatic setting manner.

In some other embodiments, presetting of the application program used for quick payment may be automatically completed by the mobile device without participation of the user. For example, the mobile device may automatically set a specific mobile payment application program as the application program used for quick payment. In some embodiments, the mobile device may set, based on different dates, the application program used for quick payment. For example, the mobile device determines whether there is mobile payment information on a current date. The mobile payment information may be a payment discount day of a mobile payment application program, for example, a discount day of Alipay (which is a popular mobile payment application program in China). This is a promotion activity launched by Alipay on a specific date, and there is a specific commodity discount on the date if mobile payment is performed by using Alipay (the payment is usually performed by scanning a barcode). When the mobile device determines that the current date is a discount day of Alipay, the mobile device may set the application program used for quick payment to Alipay. Therefore, when the user performs mobile payment, a barcode displayed on a screen (such as the display 202 of the watch 200) of the mobile device is a barcode provided by Alipay, and the barcode is used to be scanned by a scanner of a payment terminal, so as to conveniently and quickly complete mobile payment.

In some embodiments, the mobile device may determine, by using a broadcast message received through Bluetooth, whether a current date is a discount day of the mobile payment application program. For example, the Bluetooth broadcast message carries an advertisement, and content of the advertisement is: “Good news! WeChat mobile payment gets a 20% discount from December 3 to 4”. The mobile device may determine, based on the content of the advertisement, that December 3 and 4 are discount days of the mobile payment application program WeChat. Further, the mobile device may determine that the application program used for quick payment on these two days is WeChat. It may be understood that after December 4, the application program used for quick payment that is set by the mobile device may automatically change into another application program used for mobile payment, for example, an application program manually set by the user previously.

In some other embodiments, a specific mobile payment application program that has a discount day may be determined based on broadcast information sent by a WiFi hotspot to which the mobile device is connected, because the broadcast information may have discount information of the mobile payment application program. In some other embodiments, the mobile device may also set, based on a mobile payment application program that is used recently, the application program used for quick payment.

In some embodiments, if the mobile device determines that a current date is discount days of at least two mobile payment application programs, the mobile device may determine which mobile payment application program has a larger discount, so as to select a payment manner more advantageous for the user as the application program used for quick payment. It may be understood that the mobile device may also prompt the user, so that the user selects one from the at least two mobile payment application programs, and the mobile payment application program selected by the user is used as the application program used for quick payment.

In some other embodiments, the mobile device may also preset, based on different geographic locations, the application program used for quick payment. The mobile device (such as the watch 200) first determines, by using the positioning module 209, a geographic location at which the mobile device is currently located, and then determines whether there is mobile payment information, to be specific, a discount activity of a mobile payment application program, at the geographic location. Generally, when arriving at a geographic location, the mobile device receives a related message pushed by a network operator at the geographic location. The message may be a message that is strongly correlated to the geographic location. For example, after arriving in Beijing, the mobile device may receive information from a telecom operator in Beijing, and may also receive a message pushed by an advertisement service provider in Beijing. All these messages may include discount promotion information of a mobile payment application program. When the mobile device determines that the message includes discount information of a mobile payment application program, the mobile device sets, based on the information, the mobile payment application program used for quick payment, and the mobile payment application program is an application program related to the discount promotion information.

In some other embodiments, the mobile phone 300 may receive, through Bluetooth or WiFi, a discount promotion message sent by a network side. The mobile phone 300 determines, based on the discount promotion message, that there is discount information of PayPal. Then, the mobile phone determines the application program used for quick payment as PayPal. The mobile phone 300 sends information to the watch 200 by using the Bluetooth module 381. The watch 200 locally sets the application program used for quick payment to PayPal. In this way, the mobile phone 300 and the watch 200 are cooperatively used to set the application program used for quick payment.

In some other embodiments, the mobile device may specify that a priority of an application program that is used for quick payment and that is automatically set by the mobile device is higher than a priority of an application program that is used for quick payment and that is manually set by the user. For example, the user presets the application program used for quick payment to WeChat by using the method in FIG. 5, FIG. 6A, and FIG. 6B; however, because the mobile device determines the application program used for quick payment as PayPal by using the solution in the foregoing embodiment, when the user performs mobile payment, a barcode that is displayed on the screen for mobile payment is a barcode provided by PayPal. In this way, the mobile device can intelligently perform mobile payment.

In some embodiments, a method for setting the application program used for quick payment may also be implemented in the mobile phone 300, and is similar to the foregoing method.

In some other embodiments, the watch and the mobile phone may cooperate to complete the foregoing solution. For example, the watch 200 may establish a connection to the mobile phone 300 through Bluetooth or WiFi. Then, an application program used for quick payment that is used by default when the watch 200 performs mobile payment may be set on the mobile phone 300. A method for setting a payment manner on the mobile phone 300 may be approximately the same as that in FIG. 5, FIG. 6A, and FIG. 6B. A main difference is that after setting on the mobile phone 300 is completed, data obtained after the setting is completed needs to be synchronized to the watch 200 through Bluetooth or WiFi. For example, the Bluetooth 208 of the watch 200 receives data synchronized by the mobile phone 300, and then the memory 205 in the watch 200 stores the data after some basic processing is performed. In this way, the application program used for quick payment in the watch 200 is synchronized.

In the foregoing embodiment, the mobile payment application program used for quick payment is preset on the mobile device. When the mobile device performs mobile payment, the user does not need to perform some complex operations to select a specific mobile payment manner to complete payment, but the mobile device automatically determines the application program used for quick payment to perform mobile payment. In this way, time is saved, processing efficiency of the mobile device is improved, and user experience is improved.

S200. The mobile device determines whether a quick payment condition is met; and when the quick payment condition is met, displays a barcode on a display of the mobile device, where the barcode is a barcode that is used by the application program for mobile payment.

For example, the sensor 350 in the mobile phone 300 may detect in real time whether there is a particular light ray shining on the mobile phone, so that whether the quick payment condition is met is determined. When the ambient light sensor in the mobile phone 300 detects that there is a particular light ray shining on the mobile phone, the processor 380 receives data collected by the ambient light sensor, and then determines that the quick payment condition is met. In this case, the processor 380 sends a mobile payment instruction to the memory 320, to invoke the preset application program used for quick payment from the memory 320, and generate, in the application program, the barcode that can be used for mobile payment. The processor 380 sends the barcode to the display unit 340 for displaying. After receiving a display instruction from the processor 380, the display unit 340 displays the barcode.

In some other embodiments, when an acceleration sensor of the mobile device detects that an acceleration exceeds a predetermined threshold, and an ambient light sensor detects that there is a particular light ray shining on the mobile device, the mobile device may determine that the quick payment condition is met. In this scenario, the user may first take out the mobile phone from a trousers pocket, and then place the mobile phone in front of a scanner of a payment terminal. An infrared ray or a laser emitted by the scanner shines on the display unit 340 of the mobile phone 300. In this case, the mobile phone determines that the quick payment condition is met, and then the display unit 340 displays the barcode used for mobile payment.

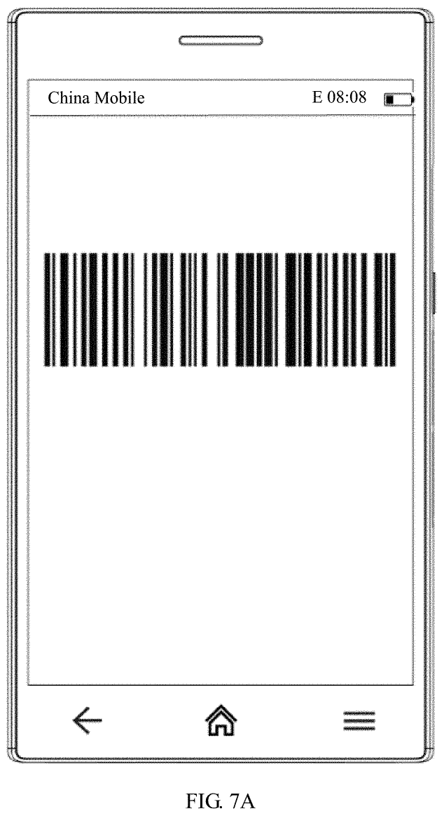

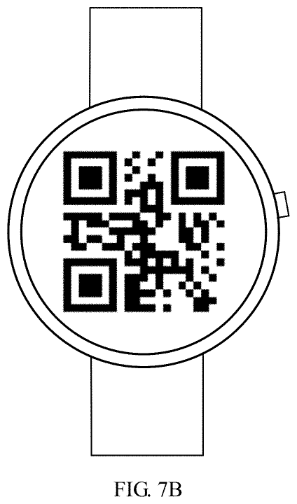

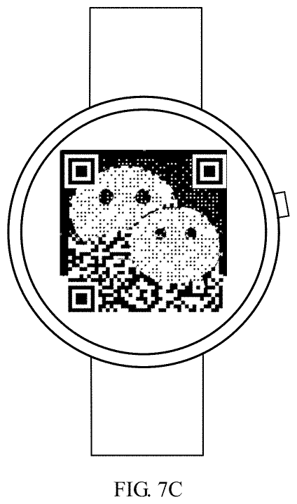

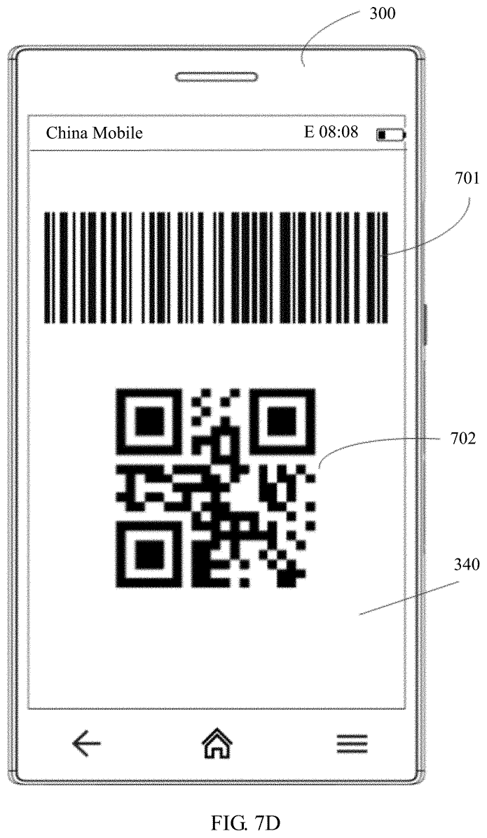

As shown in FIG. 7A, the barcode used for mobile payment may be a one-dimensional barcode displayed on the mobile phone 300. As shown in FIG. 7B, the barcode may alternatively be a QR (Quick Response) code displayed on the smartwatch 200. The QR code is a type of two-dimensional barcode. As shown in FIG. 7C, the barcode may alternatively be a three-dimensional barcode displayed on the smartwatch 200. A main feature of the three-dimensional barcode (three-dimensional code for short) is to represent and encode different data by using colors or grayscale (or referred to as black density). The three-dimensional code has a larger information capacity, same recognition convenience, and higher security. Therefore, the three-dimensional code may be applied to various important fields that require confidentiality, anti-counterfeiting, and the like. As shown in FIG. 7D, the display unit 340 of the mobile phone 300 may display two or more types of barcodes. An icon 701 indicates a one-dimensional barcode, and an icon 702 indicates a two-dimensional barcode. The two different barcodes may be displayed on the mobile device at the same time, so as to be scanned by scanners of different types of payment terminals. In this way, a mobile payment success rate can be increased. It may be understood that in addition to the barcode displayed on the mobile device, another type of barcode may be used as the barcode used for mobile payment. This is not limited in this embodiment. It may be understood that the user may touch the barcode displayed on the mobile device. After receiving the touch of the user, the mobile device zooms in and displays the barcode in an entire display area of the display.

Based on the context, the term “if” used in this embodiment may be interpreted as a meaning of “when” or “after” or “in response to determining” or “in response to detecting”. Similarly, based on the context, the phrase “if it is determined that” or “if (a stated condition or event) is detected” may be interpreted as a meaning of “when it is determined that” or “in response to determining” or “when (a stated condition or event) is detected” or “in response to detecting (a stated condition or event)”.

In some other embodiments, the foregoing solution may be implemented in the smartwatch 200.

In some other embodiments, the foregoing solution may be implemented by cooperatively using the watch 200 and the mobile phone 300. For example, the watch 200 and the mobile phone 300 establish a connection through Bluetooth or WiFi.

In the foregoing embodiment, the mobile payment application program used for quick payment is preset on the mobile device. When the mobile device performs mobile payment, the user does not need to passively select a specific mobile payment manner to complete payment, but the mobile device automatically determines the application program used for quick payment to perform mobile payment. In this way, time is saved, processing efficiency of the mobile device is improved, and user experience is improved.

In some other embodiments, after step S200, the method may further include:

S300. The mobile device receives a payment message sent by a network side, and prompts a user on the mobile device based on the payment message.

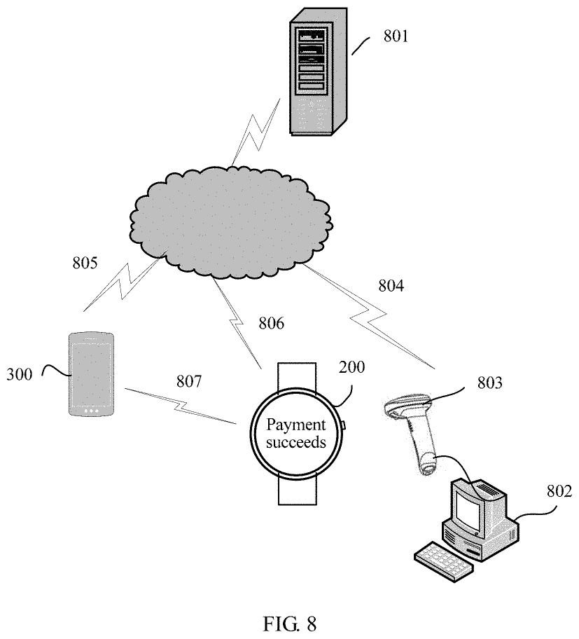

As shown in FIG. 8, after a scanner 803 of a payment terminal 802 scans the barcode displayed on the mobile device (such as a smartwatch 200 in FIG. 8), the payment terminal 802 performs preliminary processing on payment data obtained by scanning the barcode, and sends, by using a wireless link 804, the processed payment data to a network-side server 801 for operations such as decoding and authentication. After the authentication performed by the server 801 succeeds, the server 801 delivers an authentication result, to be specific, a notification indicating that mobile payment is confirmed, to the payment terminal 802 by using the wireless link 804. In addition, usually, the server 801 also sends a mobile payment success message to a mobile phone 300 by using a wireless link 805. Then, after receiving the mobile payment success message sent by the server 801, the mobile phone 300 displays a related mobile payment success message on the mobile phone 300, or plays a sound by using a speaker, so that the user learns of the mobile payment success message in time. Alternatively, the mobile phone 300 may send the payment success message to the smartwatch 200 by using a wireless link 807 (which is usually a Bluetooth link or the like). After receiving the message, the smartwatch 200 displays the payment success message on the display 202. It may be understood that alternatively, the server 801 may directly deliver the mobile payment success message to the smartwatch 200 by using a wireless link 806. In addition, certainly, the authentication performed by the server may fail. In this case, the server sends an authentication result, to be specific, a notification indicating that mobile payment fails to be confirmed, to the payment terminal. Usually, the server also sends a mobile payment failure message to the mobile device (the mobile phone 300 or the smartwatch 200), and then the mobile device prompts the user.

In some other embodiments, when the user has both the mobile phone 300 and the smartwatch 200, different mobile devices used by the user to perform mobile payment lead to different payment manners. For example, when different mobile devices are used to perform mobile payment, the mobile device (which is usually the mobile phone 300 that is used as a primary device) may be preset to use different application programs used for quick payment. For example, the application program used for quick payment may be set to WeChat when the user uses the mobile phone 300 to perform mobile payment, and the application program used for quick payment may be set to Alipay when the user uses the smartwatch 200 to perform mobile payment. It may be understood that when receiving mobile payment information, the mobile phone 300 may determine, based on a mobile payment application program that is related to the mobile payment information and that has a discount activity, an application program used for quick payment in the watch 300. In this case, although application programs used for quick payment that are set on the mobile phone 300 and the smartwatch 200 are different, for convenience of the user, the mobile phone 300 used as the primary device may change, through Bluetooth, the application program used for quick payment in the smartwatch 200 into the application program having the discount activity.

In some other embodiments, when the smartwatch 200 is used as an auxiliary device to perform mobile payment, the mobile phone used as the primary device is connected to the smartwatch, and the mobile phone may determine which mobile payment application program is to be used to perform quick payment. Certainly, the smartwatch may also determine, based on currently detected ambient light, which application program used for quick payment should be currently used by the mobile phone.

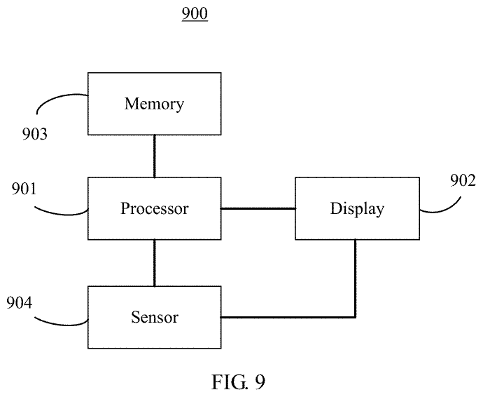

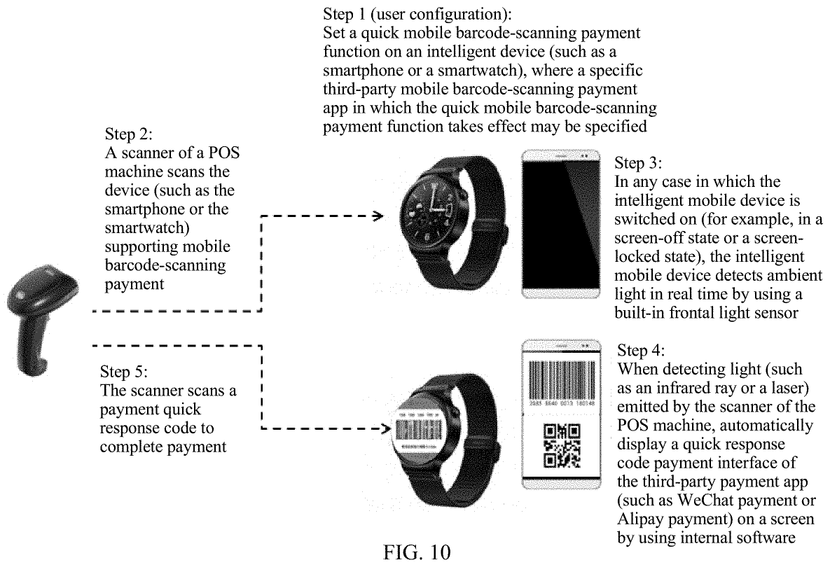

As shown in FIG. 9, an embodiment provides a mobile device 900 for transmitting data by using a barcode. The mobile device 900 includes a processor 901, a display 902, a memory 903, and one or more sensors 904.

The processor 901 sets a mobile payment application program used for quick payment, and stores the mobile payment application program in the memory 903; the processor 901 determines whether a quick payment condition is met; and when determining that the quick payment condition is met, the processor 901 displays a barcode on the display 902, where the barcode is a barcode that is used by the application program for mobile payment.

In some embodiments, after receiving a payment message sent by a network side, the processor 901 is further configured to prompt a user on the display 902 based on the payment message.

In some embodiments, that the processor 901 determines whether a quick payment condition is met may specifically include: detecting, by the one or more sensors 904, whether there is a particular light ray shining on the display 902.

In some embodiments, that the processor 902 determines whether a quick payment condition is met may specifically include: detecting, by the one or more sensors 904, whether an acceleration exceeds a predetermined threshold, and detecting whether there is a particular light ray shining on the display 902.

In some embodiments, at least two different types of barcodes are displayed on the display 902.

The barcode is a one-dimensional barcode, a two-dimensional barcode, or a three-dimensional barcode.

In some embodiments, that the processor 901 sets a mobile payment application program used for quick payment may specifically include: automatically setting, by the processor 901 based on a date or a geographic location, the mobile payment application program used for quick payment.

As shown in FIG. 10, a quick payment method in an embodiment includes the following steps: Step 1: Set a quick mobile barcode-scanning payment function on an intelligent device (such as a smartphone or a smartwatch), where a specific third-party mobile barcode-scanning payment application program in which the quick mobile barcode-scanning payment function takes effect may be specified. Step 2: A scanner of a payment terminal (such as a POS machine) scans the intelligent device supporting mobile barcode-scanning payment. Step 3: In any case in which the intelligent device is switched on (for example, in a screen-off state or a screen-locked state), the intelligent device detects ambient light in real time by using a built-in light sensor. Step 4: When detecting light (such as an infrared ray or a laser) emitted by the scanner of the POS machine, the intelligent device automatically displays a two-dimensional barcode payment interface of the third-party payment application program (such as WeChat or Alipay) on a screen by using internal software.

The mobile payment application program described in the embodiment is not limited to the foregoing illustrated application programs, and also includes other application programs such as Le Pay, Huawei Pay, and Samsung Pay that can complete a payment process through mobile payment.

In some other embodiments, a mobile payment manner may be NFC payment. An application program used for quick payment is set on a mobile device, so that when a user performs NFC payment next time, NFC quick payment can be performed without a user operation. For a specific technical solution of the quick payment, refer to the technical solutions in the foregoing embodiments.

The terms used in the foregoing embodiments are merely for the purpose of illustrating particular embodiments, and are not intended to limit this application. The terms “a”, “said” and “the” of singular forms used in the foregoing embodiments and the claims are also intended to include plural forms, unless otherwise specified in the context clearly. It should also be understood that the term “and/or” used herein indicates and includes any or all possible combinations of one or more associated listed items.

It should be noted that persons of ordinary skill in the art may understand that all or some of the processes of the methods in the foregoing embodiments may be implemented by a computer program instructing relevant hardware. The program may be stored in a computer readable storage medium. The processes of the methods in the foregoing embodiments may be performed when the program runs. The storage medium may be: a magnetic disk, an optical disc, a read-only memory, a random access memory, or the like.

For a purpose of explanation, the foregoing descriptions are provided with reference to the specific embodiments. However, the foregoing example discussion is not intended to be detailed, and is not intended to limit the present invention to a disclosed precise form. Based on the foregoing teaching content, many modification forms and variation forms are possible. The embodiments are selected and described to fully illustrate the principles of the present invention and practical application of the principles, so that other persons skilled in the art can make full use of the present invention and various embodiments that have various modifications applicable to conceived specific usage.

1-2. (canceled)

3. A method for transmitting data by using a barcode, wherein the method comprises:
installing, on a mobile device, multiple mobile payment applications used for quick payment;
determining, by the mobile device, whether a quick payment condition is met; and
in response to determining that the quick payment condition is met, automatically displaying a barcode on a display of the mobile device, wherein the barcode is a barcode that is used by an application for mobile payment.

4. The method according to claim 3, wherein the method further comprises:
receiving, by the mobile device, a payment message sent by a network side, and prompting a user with the payment message on the mobile device.

5. The method according to claim 3, wherein the determining, by the mobile device, whether a quick payment condition is met comprises detecting, by a sensor in the mobile device, whether a particular light ray is shining on the mobile device.

6. The method according to claim 3, wherein the determining, by the mobile device, whether a quick payment condition is met comprises:
detecting, by an acceleration sensor in the mobile device, whether an acceleration exceeds a preset threshold; and
detecting, by an ambient light sensor, whether a particular light ray is shining on the mobile device.

7. The method according to claim 3, wherein the displaying a barcode on a display of the mobile device comprises displaying at least two different types of barcodes on the display at the same time.

8. The method according to claim 7, wherein the barcode is a one-dimensional barcode or a two-dimensional barcode.

9. The method according to claim 3, wherein the installing, on the mobile device, multiple mobile payment applications used for quick payment comprises:
automatically setting, by the mobile device and based on a date or a geographic location, a mobile payment application program used for quick payment.

10. A mobile device for transmitting data by using a barcode, wherein the mobile device comprises one or more processors, a display, a memory, and one or more programs, wherein the one or more programs are stored in the memory, and wherein when the one or more programs are executed by the one or more processors cause the mobile device to perform operations comprising:
receiving a mobile payment instruction;
determining whether mobile payment information exists, wherein the mobile payment information is discount information of a mobile payment application;
determining, based on the discount information, an application for performing mobile payment;
determining, through detection by using a light sensor, whether a particular light ray emitted by a scanner of a payment terminal is shining on the mobile device;
in response to determining that the particular light ray is shining on the mobile device, invoking a barcode that is used by the application program for mobile payment, and displaying the barcode on the display of the mobile device; and
receiving a payment success message sent by a network side, and displaying a payment success user interface on the display.

11. A mobile device for transmitting data by using a barcode, wherein the mobile device comprises:
at least one processor, a display, a memory, and one or more sensors, wherein:
the at least one processor sets a mobile payment application used for quick payment, and stores the mobile payment application in the memory;
the at least one processor determines whether a quick payment condition is met; and
in response to determining that the quick payment condition is met, the at least one processor displays a barcode on the display, wherein the barcode is a barcode that is used by the application for mobile payment.

12. The mobile device according to claim 11, wherein after receiving a payment message sent by a network side, the at least one processor prompts a user the payment message on the display.

13. The mobile device according to claim 11, wherein that the at least one processor determines whether a quick payment condition is met comprises detecting, by the one or more sensors, whether a particular light ray is shining on the display.

14. The mobile device according to claim 11, wherein that the at least one processor determines whether a quick payment condition is met comprises:
detecting, by the one or more sensors, whether an acceleration exceeds a predetermined threshold; and
detecting whether a particular light ray is shining on the display.

15. The mobile device according to claim 14, wherein at least two different types of barcodes are displayed on the display.

16. The mobile device according to claim 15, wherein the barcode is a one-dimensional barcode or a two-dimensional barcode.

17. The mobile device according to claim 11, wherein that the at least one processor sets a mobile payment application used for quick payment comprises:
automatically setting, by the processor and based on a date or a geographic location, the mobile payment application used for quick payment.

18. The mobile device according to claim 10, the operations further comprise:
determining a geographic location of a wearable device;
receiving the mobile payment information based on the geographic location; and
determining a first application for quick payment based on the mobile payment information.

19. The mobile device according to claim 18, wherein the barcode is a one-dimensional barcode or a two-dimensional barcode.
